(19) United States
(12) Patent Application Publication
(10) Pub. No.: US 2026/0312765 A1
(43) Pub. Date: Oct. 8, 2026

(54) UPLINK SOUNDING REFERENCE SIGNAL

(71) Applicant: Samsung Electronics Co., Ltd., Suwon-si (KR)

(72) Inventors: Javad Abdoli, Plano, TX (US); Mehmet Mert Sahin, Frisco, TX (US); Xinliang Zhang, Plano, TX (US); Young Han Nam, Plano, TX (US)

(21) Appl. No.: 19/561,191

(22) Filed: Mar. 9, 2026

Related U.S. Application Data
(60) Provisional application No. 63/783,505, filed on Apr. 4, 2025.
(60) Provisional application No. 63/880,941, filed on Sep. 12, 2025.

(51) Int. Cl. H04L 5/00

(52) U.S. Cl. CPC H04L 5/0051; H04L 5/0007; H04L 5/0091

(57) ABSTRACT

A user equipment (UE) includes a transceiver configured to receive, from a base station (BS), downlink control information (DCI) including a trigger to transmit an uplink (UL) reference signal (RS). The UE also includes a processor operably coupled to the transceiver. The processor is configured to generate the UL RS based on a UL demodulation reference signal (DMRS). The transceiver is further configured to transmit the UL RS.

### CROSS-REFERENCE TO RELATED APPLICATIONS AND CLAIM OF PRIORITY

This application claims priority under 35 U.S.C. § 119(e) to U.S. Provisional Patent Application No. 63/783,505 filed on Apr. 4, 2025, and U.S. Provisional Patent Application No. 63/880,941 filed on Sep. 12, 2025. The above-identified provisional patent applications are hereby incorporated by reference in their entirety.

### TECHNICAL FIELD

This disclosure relates generally to wireless networks. More specifically, this disclosure relates to uplink (UL) sounding reference signals (SRSs).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveforms (e.g., new radio access technologies [RATs]) to flexibly accommodate various services/applications with different requirements, new multiple access schemes to support massive connections, etc.

### SUMMARY

This disclosure provides apparatuses and methods to support uplink sounding reference signals in wireless networks.

In one embodiment, a user equipment (UE) is provided. The UE includes a transceiver configured to receive, from a base station (BS), downlink control information (DCI) including a trigger to transmit an uplink (UL) reference signal (RS). The UE also includes a processor operably coupled to the transceiver. The processor is configured to generate the UL RS based on a UL demodulation reference signal (DMRS). The transceiver is further configured to transmit the UL RS.

In another embodiment, a BS is provided. The BS includes a processor, and a transceiver operably coupled to the processor. The transceiver is configured to transmit, to a UE, DCI including a trigger to transmit an UL RS, and receive the UL RS from the UE. The UL RS is generated based on a UL DMRS.

In yet another embodiment, a method of operating a UE is provided. The method includes receiving, from a BS, DCI including a trigger to transmit an UL RS. The method also includes generating the UL RS based on a UL DMRS, and transmitting the UL RS.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example antenna beamforming architecture according to embodiments of the present disclosure;

FIG. 5 illustrates an example of DMRS OFDM symbols multiplexed with data according to embodiments of the present disclosure;

FIG. 6 illustrates an example of DMRS OFDM symbols not multiplexed with data according to embodiments of the present disclosure;

FIG. 7 illustrates an example of TDM of SRS Type-2 ports for a UE according to embodiments of the present disclosure;

FIG. 8 illustrates an example of FDM of SRS Type-2 ports for a UE according to embodiments of the present disclosure;

FIG. 9 illustrates an example of CDM of SRS Type-2 ports for a UE according to embodiments of the present disclosure;

FIG. 10 illustrates an example of a combination of FDM and TDM of SRS Type-2 ports for a UE according to embodiments of the present disclosure;

FIG. 11 illustrates an example Extended UL DMRS transmission for a UE with 2 TX antennas, scheduled with rank-1 PUSCH without DMRS power boosting according to embodiments of the present disclosure;

FIG. 12 illustrates an example Extended UL DMRS transmission for a UE with 2 TX antennas, scheduled with rank-1 PUSCH with DMRS power boosting according to embodiments of the present disclosure;

FIG. 13 illustrates an example procedure for DMRS port extension according to embodiments of the present disclosure;

FIG. 14 illustrates an example procedure for extended DMRS port dropping according to embodiments of the present disclosure;

FIG. 15 illustrates an example of PUSCH rate-matching around full OFDM symbol(s) of NZP SRS Type-2 according to embodiments of the present disclosure;

FIG. 16 illustrates an example of PUSCH rate-matching around NZP SRS Type-2 REs according to embodiments of the present disclosure;

FIG. 17 illustrates an example of PUSCH rate-matching around full OFDM symbol(s) of ZP SRS Type-2 according to embodiments of the present disclosure;

FIG. 18 illustrates an example of PUSCH rate-matching around ZP SRS Type-2 REs according to embodiments of the present disclosure;

FIG. 19 illustrates an example method for transmission of an UL RS according to embodiments of the present disclosure; and

FIG. 20 illustrates an example method for reception of an UL RS according to embodiments of the present disclosure.

### DETAILED DESCRIPTION

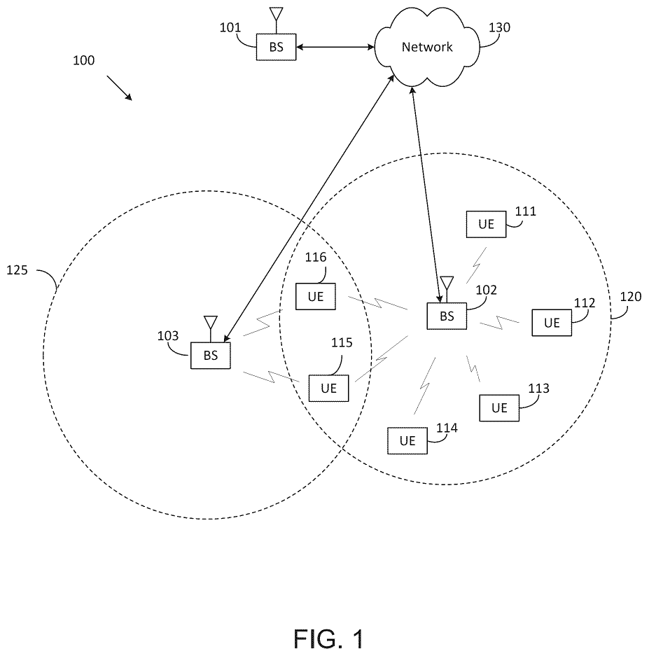

FIGS. 1 through 20, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for generation and transmission of uplink sounding reference signals. In certain embodiments, one or more of the gNBs 101-103 includes circuitry, programing, or a combination thereof, to support uplink sounding reference signals in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

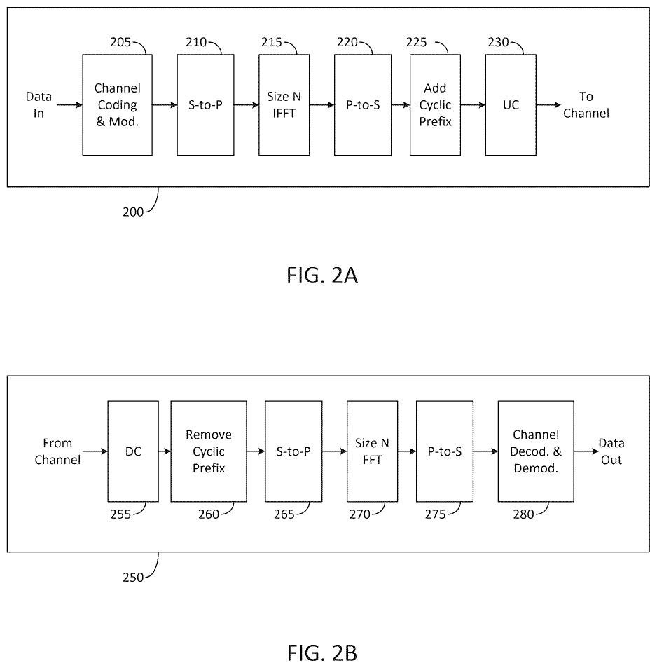

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support uplink sounding reference signals as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

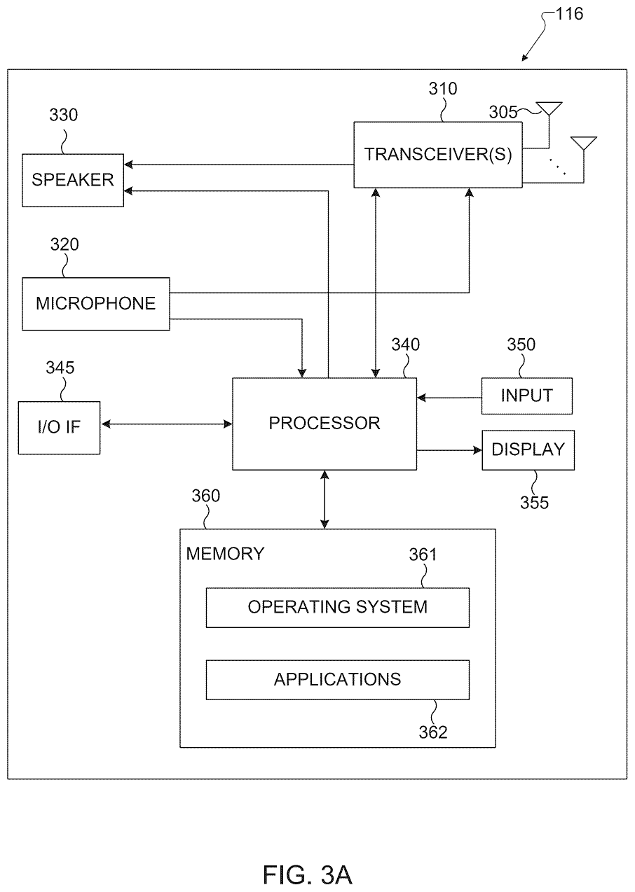

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for uplink sounding reference signals as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support uplink sounding reference signals as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports will remain more or less the same.

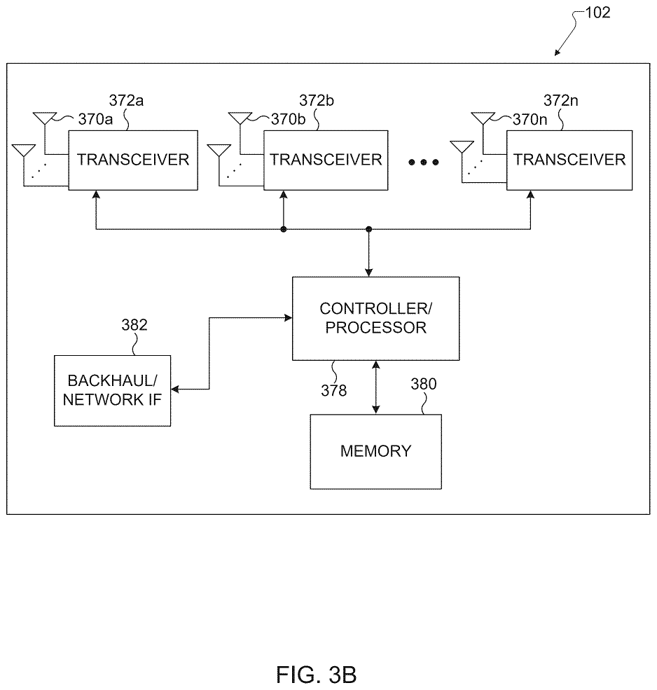

For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated by beamforming architecture 400 in FIG. 4.

FIG. 4 illustrates an example antenna beamforming architecture 400 according to embodiments of the present disclosure. The embodiment of the antenna beamforming architecture illustrated in FIG. 4 is for illustration only. Different embodiments of an antenna beamforming architecture could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Although FIG. 4 illustrates one example antenna beamforming architecture 400, various changes may be made to FIG. 4. For example, various components in FIG. 4 could be combined, further subdivided, or omitted and additional components could be added according to particular needs.

In a cellular communication system, different UL reference signals are used for different purposes:

UL channel sounding refers to transmission of a UL sounding reference signal (SRS) by a UE and estimation of the UE's UL channel by a BS using a received UL SRS transmission. The main purpose of the UL channel sounding is to enable a BS to obtain different UEs' UL channel state information (CSI). UL CSI can be used by a BS for making UL scheduling decisions and/or UL precoder determination or making DL scheduling decisions and/or DL precoder determination if DL/UL channel reciprocity exists.

On the other hand, a UL demodulation reference signal (DMRS) is a certain reference signal (RS) which is transmitted by a UE together with an associated UL data channel (i.e., a physical uplink shared channel [PUSCH]) or UL control channel (i.e., a physical uplink control channel [PUCCH]). The main purpose of a UL DMRS transmission is to enable a BS to estimate the UL wireless channel over the associated transmitted PUSCH or PUCCH resources and decode the PUSCH or PUCCH after equalizing the wireless channel.

In 5G NR, UL DMRS and SRS are configured and generated separately via different RS generation procedures using different types of sequences, time/frequency configurations, ports, etc. In some PUSCH transmissions, the number of DMRS ports is equal to the number of PUSCH layers. The network (NW) indicates whether the PUSCH is to be frequency multiplexed with the DMRS on the same OFDM symbol in downlink control information (DCI), using a “number of DMRS code division multiplexing (CDM) groups without data”.

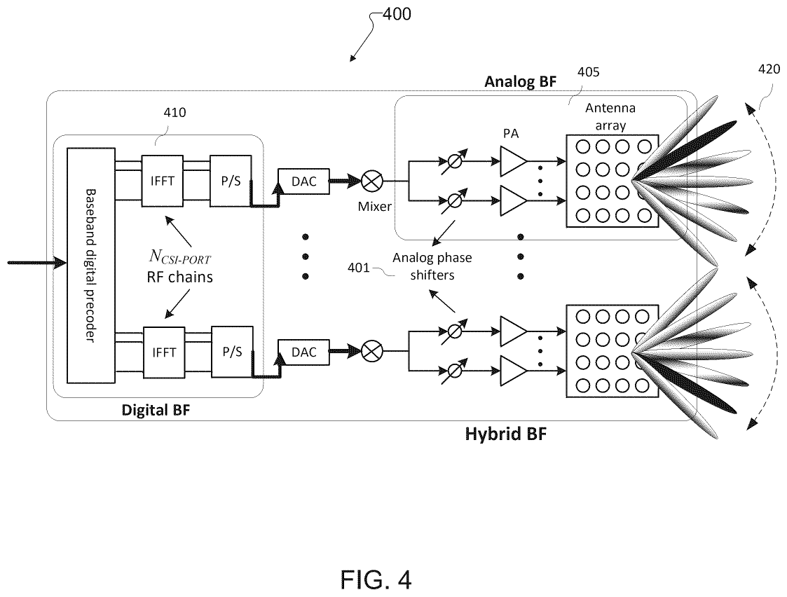

FIG. 5 illustrates an example of DMRS OFDM symbols multiplexed with data 500 according to embodiments of the present disclosure. The embodiment of DMRS OFDM symbols multiplexed with data of FIG. 5 is for illustration only. Different embodiments of DMRS OFDM symbols multiplexed with data could be used without departing from the scope of this disclosure.

FIG. 5 demonstrates a case where DMRS OFDM symbols are multiplexed with data having one DMRS port and one PUSCH layer, when DMRS configuration type 1 and PUSCH mapping type A is configured according to 5G NR specifications. In this case, DMRS energy per resource element (EPRE) is the same as PUSCH EPRE. In the example of FIG. 5, PUSCH data starts from the first OFDM symbol and is allocated to all 14 OFDM symbols. DMRS symbols are only allocated at the 4^{th} OFDM symbol where every second subcarrier is allocated with the DMRS symbol. The table in FIG. 5 explains the power allocation of PUSCH and DMRS REs, where the power P is allocated for both PUSCH and DMRS REs making the total power per RB 12P.

Although FIG. 5 illustrates one example of DMRS OFDM symbols multiplexed with data 500, various changes may be made to FIG. 5. For example, various changes to the number of RBs could be made, the allocation of the DMRS OFDM symbols could change, etc. according to particular needs.

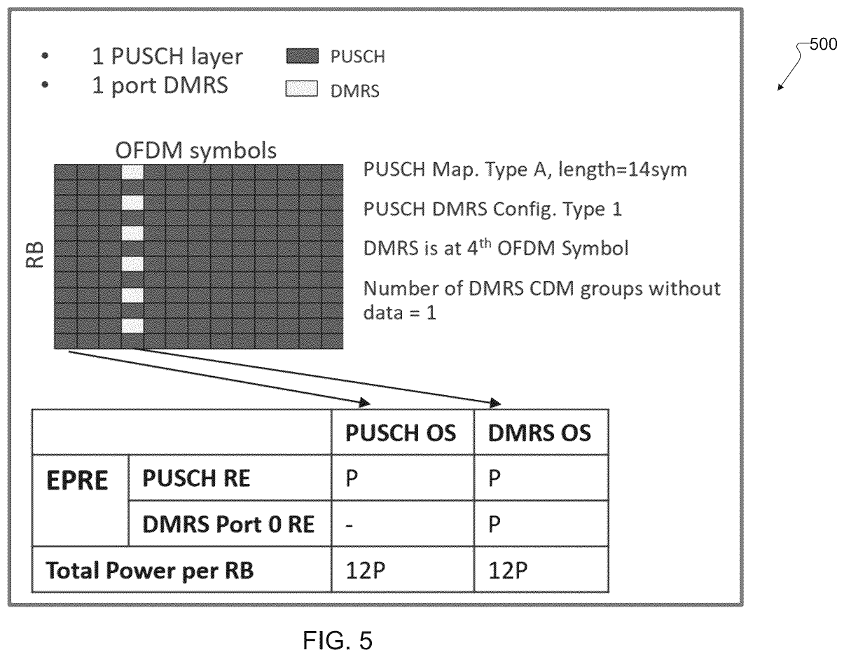

FIG. 6 illustrates an example of DMRS OFDM symbols not multiplexed with data 600 according to embodiments of the present disclosure. The embodiment of DMRS OFDM symbols not multiplexed with data of FIG. 6 is for illustration only. Different embodiments of DMRS OFDM symbols not multiplexed with data could be used without departing from the scope of this disclosure.

FIG. 6 depicts a case where DMRS OFDM symbols are not multiplexed with the data which is indicated through DCI setting the number of DMRS CDM groups without data as 2. In this case, half of the subcarriers in an RB of the 4^{th} OFDM symbol include only DMRS symbols. Therefore, the DMRS EPRE is 3 dB higher than the PUSCH EPRE. The table in FIG. 6 explains the power allocation of PUSCH and DMRS REs. Power per resource element is P for PUSCH data, however, it is 2P for DMRS symbols. For both PUSCH and DMRS OFDM symbols, the total power per RB is 12P.

Although FIG. 6 illustrates one example of DMRS OFDM symbols not multiplexed with data 600, various changes may be made to FIG. 6. For example, various changes to the number of RBs could be made, the allocation of the DMRS OFDM symbols could change, etc. according to particular needs.

In the present disclosure, SRS type-2 refers to an RS used for UL channel sounding that can be triggered on any one or more time-frequency resources.

In some embodiments, SRS type-2 sequence and RE mapping can be according to the SRS generation and mapping procedure.

In some embodiments, SRS type-2 sequence and RE mapping can be according to the DMRS generation and mapping procedure. In the present disclosure, the terms “SRS Type-2”, “Non-Zero-Power (NZP) SRS Type-2”, “DMRS without PUSCH”, and “Non-Zero-Power (NZP) DMRS without PUSCH” are used interchangeably.

In some embodiments, SRS Type-2 is an UL RS which is generated based on an UL DMRS and is used for UL channel sounding purposes. In embodiments such as these, a BS can use SRS Type-2 to obtain UL CSI of a UE. The obtained UL CSI can be used by the BS, for example, for making UL scheduling decisions and/or UL precoder determinations or making DL scheduling decisions and/or DL precoder determinations if DL/UL channel reciprocity exists.

In some embodiments, for each SRS Type-2 port, the RS sequence generation can follow the same sequence generation procedure of UL DMRS. For example, in 5G NR, the UL DMRS sequence is a pseudo-random binary sequence which is modulated using QPSK modulation. In embodiments such as these, SRS Type-2 is also a pseudo-random binary sequence which is modulated using QPSK modulation.

In some embodiments, a PUSCH is scheduled for a UE and an SRS Type-2 is configured and triggered for the UE in a same transmission time interval (TTI) or same slot. In embodiments such as these, the SRS Type-2 can be configured and triggered to be transmitted on any subset of time/frequency resource(s) where the PUSCH is scheduled.

In some embodiments, a PUSCH is scheduled for a UE in a TTI/slot, and an SRS Type-2 is configured and triggered for the UE in a different TTI/slot. In embodiments such as these, the SRS Type-2 can be configured in any time/frequency resource(s) of the different TTI/slot.

In some embodiments, a DCI which is transmitted in a physical downlink control channel (PDCCH) is used to trigger a UE to transmit an SRS Type-2 and also to indicate information required for SRS Type-2 transmission, including time/frequency resources and antenna ports.

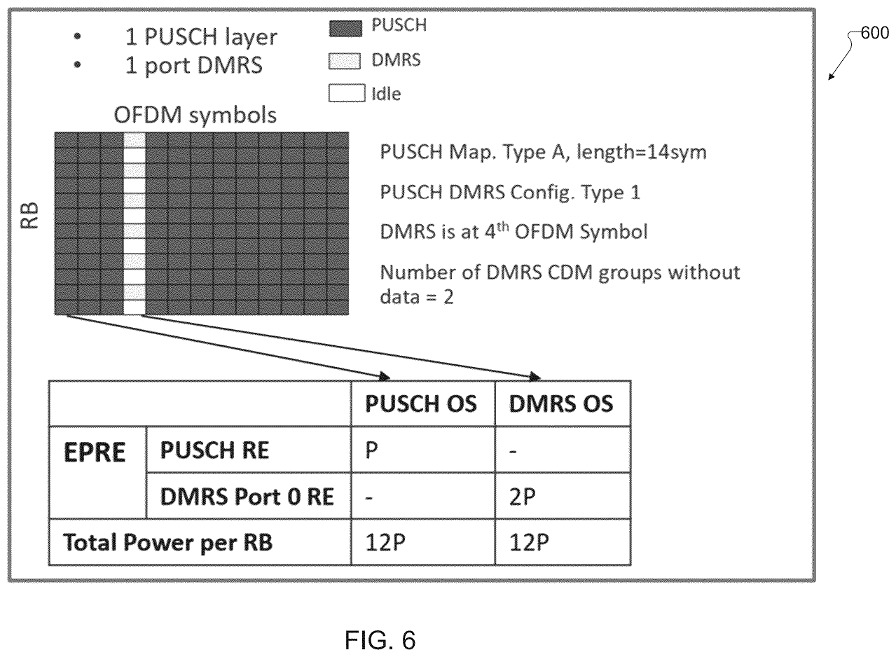

In some embodiments, different SRS Type-2s of a UE or different UEs can be multiplexed with each other using time-division multiplexing (TDM), wherein the SRS Type-2 ports are transmitted over different OFDM symbols, or frequency-division multiplexing (FDM), wherein different SRS Type-2 ports are transmitted over different subcarriers, or code-division multiplexing (CDM), wherein different SRS Type-2 ports are transmitted over the same OFDM symbol(s) and same subcarrier(s) using different orthogonal cover codes (OCCs), or a using combination of TDM and/or FDM and/or CDM. FIG. 7 through FIG. 10 illustrate some examples of multiplexing of different SRS Type-2s.

FIG. 7 illustrates an example of TDM of SRS Type-2 ports for a UE 700 according to embodiments of the present disclosure. The embodiment of TDM of SRS Type-2 ports for a UE of FIG. 7 is for illustration only. Different embodiments of TDM of SRS Type-2 ports for a UE could be used without departing from the scope of this disclosure.

In the example of FIG. 7, ports #1 and #2 of a 2-port SRS Type-2 for UE are time-division multiplexed over different OFDM symbols. It can be seen that port #1 is allocated to every other subcarrier of the second OFDM symbol, while port #2 is allocated to the same subcarriers as port #1 of the third OFDM symbol.

Although FIG. 7 illustrates one example of TDM of SRS Type-2 ports for a UE 700, various changes may be made to FIG. 7. For example, various changes to the frequency allocations could be made, various changes to the slot allocations could be made, etc. according to particular needs.

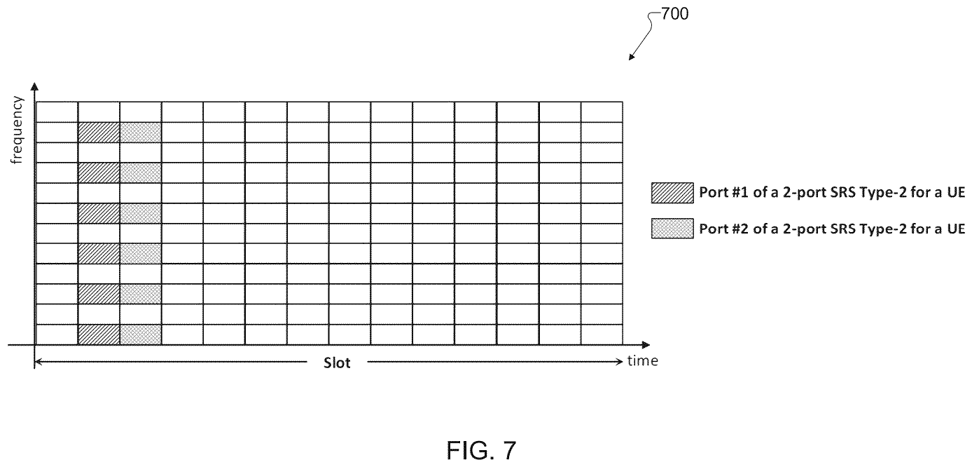

FIG. 8 illustrates an example of FDM of SRS Type-2 ports for a UE 800 according to embodiments of the present disclosure. The embodiment of FDM of SRS Type-2 ports for a UE of FIG. 8 is for illustration only. Different embodiments of FDM of SRS Type-2 ports for a UE could be used without departing from the scope of this disclosure.

In the example of FIG. 8, ports #1 and #2 of a 2-port SRS Type-2 for UE are frequency-division multiplexed in the same OFDM symbol. It can be seen that port #1 is allocated to every other subcarrier of the second OFDM symbol, while port #2 is allocated to the subcarriers in the second OFDM symbol interleaving the subcarriers allocated to port #1.

Although FIG. 8 illustrates one example of FDM of SRS Type-2 ports for a UE 800, various changes may be made to FIG. 8. For example, various changes to the frequency allocations could be made, various changes to the slot allocations could be made, etc. according to particular needs.

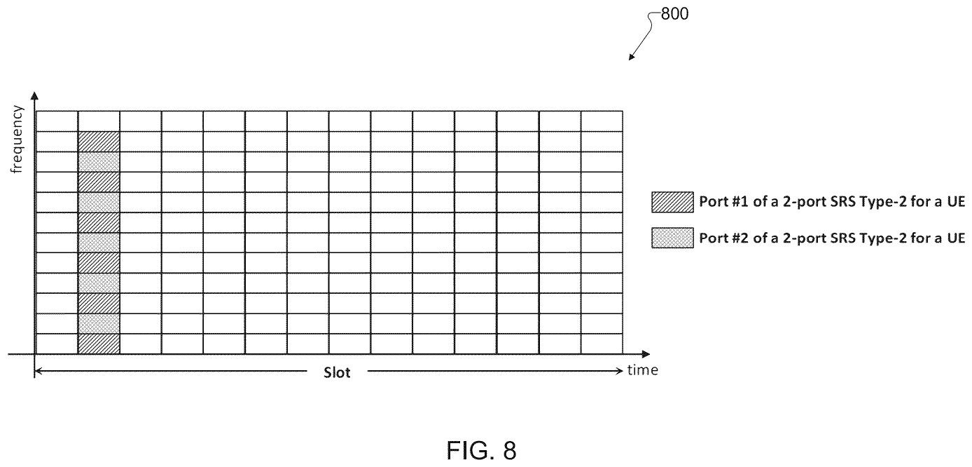

FIG. 9 illustrates an example of CDM of SRS Type-2 ports for a UE 900 according to embodiments of the present disclosure. The embodiment of CDM of SRS Type-2 ports for a UE of FIG. 9 is for illustration only. Different embodiments of CDM of SRS Type-2 ports for a UE could be used without departing from the scope of this disclosure.

In the example of FIG. 9, ports #1 and #2 of a 2-port SRS Type-2 for UE are code-division multiplexed in the same OFDM symbol, with port #1 using an OCC #1, and port #2 using an OCC #2. It can be seen that port #1 and port #1 are allocated to every other subcarrier of the second OFDM symbol as alternating CDM groups.

Although FIG. 9 illustrates one example of CDM of SRS Type-2 ports for a UE 900, various changes may be made to FIG. 9. For example, various changes to the frequency allocations could be made, various changes to the slot allocations could be made, etc. according to particular needs.

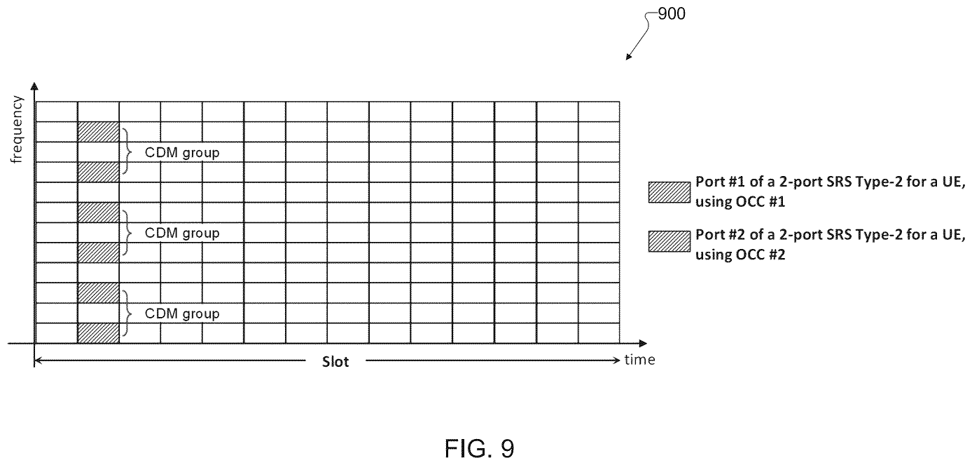

FIG. 10 illustrates an example of a combination of FDM and TDM of SRS Type-2 ports for a UE 1000 according to embodiments of the present disclosure. The embodiment of the combination of FDM and TDM of SRS Type-2 ports for a UE of FIG. 1000 is for illustration only. Different embodiments of a combination of FDM and TDM of SRS Type-2 ports for a UE could be used without departing from the scope of this disclosure.

In the example of FIG. 10, ports #1, #2, #3, and #4 of a 4-port SRS Type-2 for UE are frequency-division multiplexed and time-division multiplexed over different OFDM symbols. It can be seen that port #1 is allocated to every other subcarrier of the second OFDM symbol, while port #2 is allocated to the subcarriers in the second OFDM symbol interleaving the subcarriers allocated to port #1. It can also be seen that port #3 is allocated to the same subcarriers as port #1 in the sixth OFDM symbol, while port #4 is allocated to the same subcarriers as port #2 in the sixth OFDM symbol.

Although FIG. 10 illustrates one example of a combination of FDM and TDM of SRS Type-2 ports for a UE 1000, various changes may be made to FIG. 10. For example, various changes to the frequency allocations could be made, various changes to the slot allocations could be made, etc. according to particular needs.

In some embodiments, a UE can be scheduled to transmit a PUSCH, wherein the number of DMRS ports for the PUSCH is more than the scheduled number of PUSCH layers. In the present disclosure, this is referred to as “DMRS port extension.”

In some embodiments, DMRS port extension is activated only for UEs configured with non-coherent codebook transmission.

In some embodiments, for DMRS port extension, N_{D} UL DMRS ports are transmitted by a UE together with corresponding N_{D} scheduled PUSCH layers in a TTI/slot and N_{S} UL DMRS ports are transmitted by the UE for UL channel sounding purposes without any corresponding PUSCH in the TTI/slot. In embodiments such as these, N_{D}+N_{S} does not exceed a total number of N_{TX} UE TX antenna ports (i.e., N_{D}+N_{S}≤N_{TX}). The N_{S} UL DMRS ports may also be referred to as “SRS Type-2” or “extended DMRS ports” in the present disclosure.

In some embodiments, extended DMRS ports are configured similar to normal PUSCH DMRS configuration.

In some embodiments, a DCI is used to trigger transmission of extended DMRS ports and indicate DMRS port numbers for the extended DMRS transmission.

In some embodiments, power control for an extended DMRS port follows the same power control as a scheduled PUSCH regardless of whether the UE is power limited.

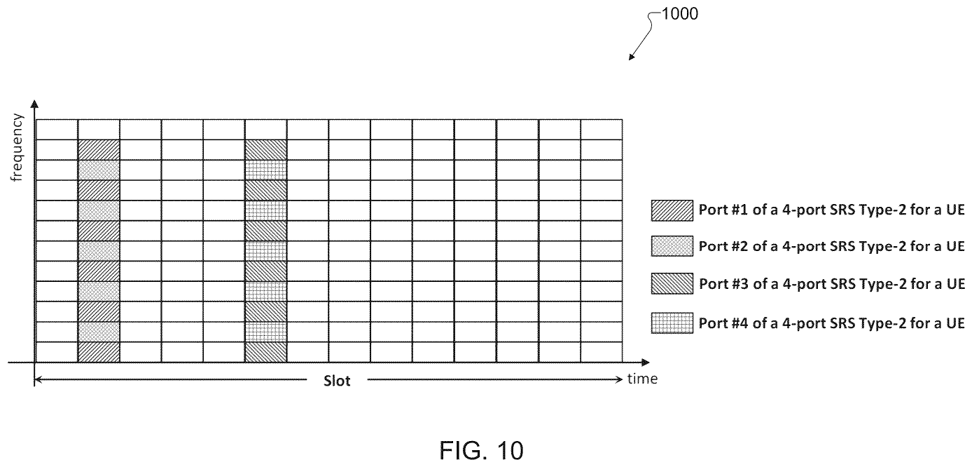

FIG. 11 illustrates an example Extended UL DMRS transmission for a UE with 2 TX antennas, scheduled with rank-1 PUSCH without DMRS power boosting 1100 according to embodiments of the present disclosure. The embodiment of Extended UL DMRS transmission of FIG. 11 is for illustration only. Different embodiments of Extended UL DMRS transmission could be used without departing from the scope of this disclosure.

FIG. 11 shows an example of an extended UL DMRS transmission for a UE with 2 TX antennas, scheduled with rank-1 PUSCH and DMRS power boosting is disabled, where the data is multiplexed with DMRS symbols. When a one-bit codepoint indicating DMRS port extension in the DCI is set to 0, a PUSCH transmission occurs where the DMRS symbols are only allocated to 4th OFDM symbol in a frequency domain multiplexed with PUSCH data implying DMRS power boosting is disabled which is indicated by a field in a ‘Antenna Ports’ field in the DCI 0_1. If a one-bit codepoint indicating DMRS port extension in the DCI is set to 1, a second DMRS port is transmitted with equal power of first DMRS port. Therefore, the OFDM symbol that carries the DMRS signals has 1.5 times more power than the OFDM symbol carrying only PUSCH data. Power per RE for PUSCH, DMRS Port 0 and DMRS Port 1 is the same and denoted as P in FIG. 11. Therefore, the total power per RB in the DMRS OFDM symbol is 18P while it is 12P in the PUSCH OFDM symbol.

Although FIG. 11 illustrates one example Extended UL DMRS transmission for a UE with 2 TX antennas, scheduled with rank-1 PUSCH without DMRS power boosting 1100, various changes may be made to FIG. 11. For example, various changes to the number of RBs could be made, the allocation of the DMRS OFDM symbols could change, etc. according to particular needs.

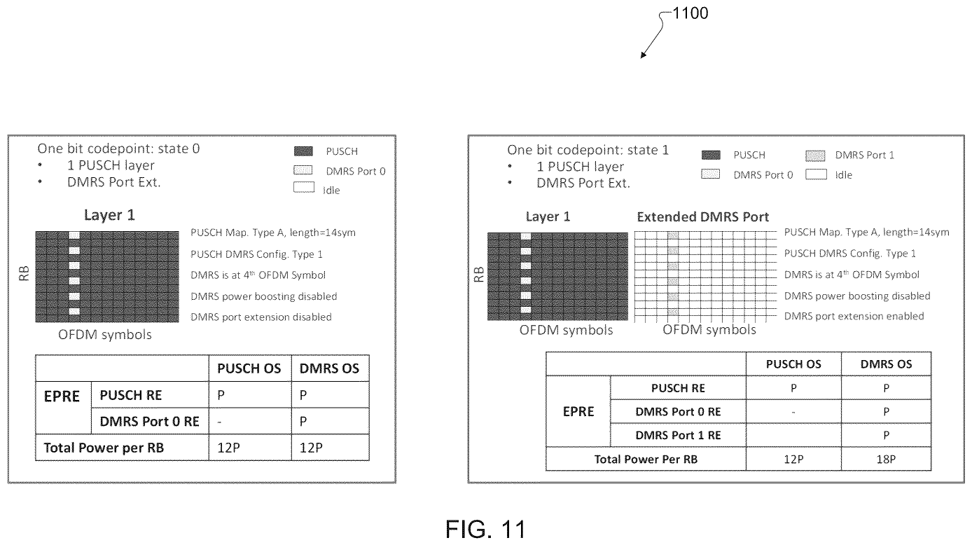

FIG. 12 illustrates an example Extended UL DMRS transmission for a UE with 2 TX antennas, scheduled with rank-1 PUSCH with DMRS power boosting 1200 according to embodiments of the present disclosure. The embodiment of Extended UL DMRS transmission of FIG. 12 is for illustration only. Different embodiments of Extended UL DMRS transmission could be used without departing from the scope of this disclosure.

FIG. 12 shows example of an extended UL DMRS port transmission for a UE with 2 TX antennas, scheduled with rank-1 PUSCH and DMRS where power boosting is enabled and where the data is not multiplexed with DMRS symbols. When a one bit codepoint indicating DMRS port extension in the DCI is set to 0, a PUSCH transmission occurs where DMRS symbols are only allocated to the 4th OFDM symbol in a frequency domain which is not multiplexed with PUSCH data implying DMRS power boosting is enabled which is indicated by a field in a DCI. If a one-bit codepoint indicating DMRS port extension in the DCI is set to 1, a second DMRS port is transmitted with equal power of first DMRS port. Therefore, the OFDM symbol that carries the DMRS signals has 2 times more power than the OFDM symbol carrying only PUSCH data. Power per RE for PUSCH in the PUSCH OFDM symbol is denoted as P, whereas the power of DMRS Port 0 and DMRS Port 1 in the DMRS OFDM symbol is the same and denoted as 2P which is shown in FIG. 12. Therefore, total power per RB in the DMRS OFDM symbol is 24P while it is 12P in the PUSCH OFDM symbol.

Although FIG. 12 illustrates one example Extended UL DMRS transmission for a UE with 2 TX antennas, scheduled with rank-1 PUSCH with DMRS power boosting 1200, various changes may be made to FIG. 12. For example, various changes to the number of RBs could be made, the allocation of the DMRS OFDM symbols could change, etc. according to particular needs.

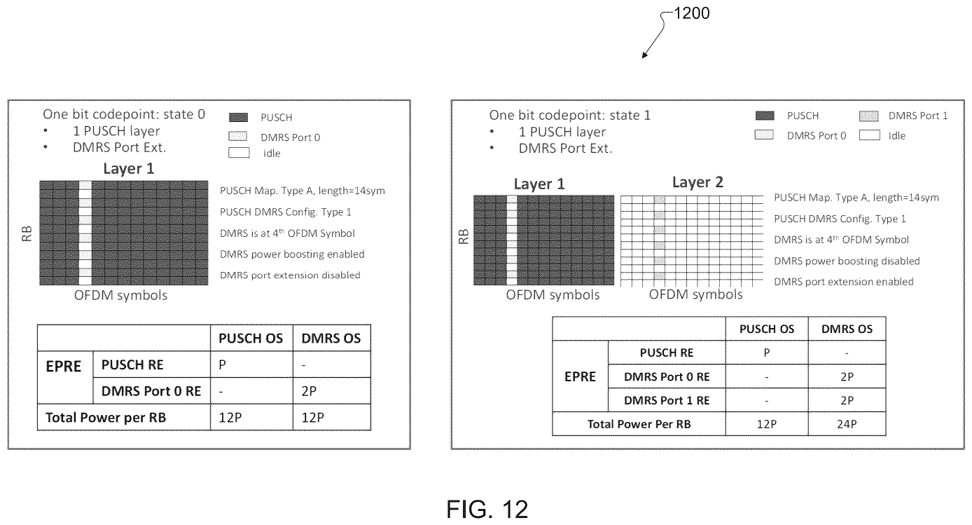

In some embodiments, a one-bit information embedded in a DCI intended for a UE for a PUSCH scheduling is used for triggering DMRS port extension. In embodiments such as these, a DMRS port extension procedure may be performed, similar as shown in FIG. 13.

FIG. 13 illustrates an example procedure for DMRS port extension 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for DMRS port extension could be used without departing from the scope of this disclosure.

In the example of FIG. 13, procedure 1300 beings at operation 1302. At operation 1302, a UE receives a message (such as an RRC, or MAC-CE, or DCI) including one-bit information indicating whether DMRS port extension is enabled. In some embodiments, a first state of the one-bit information corresponds to ‘1’, and a second state corresponds to ‘0’. Alternatively, in some embodiments, the first state of the one-bit information corresponds to ‘0’, and the second state corresponds to ‘1’.

At operation, 1304, the UE determines whether the state of the DMRS port extension is a first state or second state. If the bit information is in the first state (e.g., “1”), the procedure continues at operation 1306. Otherwise, if the bit information is in the second state (e.g., “0”), the procedure continues at operation 1308.

At operation 1306, the UE the UE is configured to transmit a same number of DMRS ports as a number of scheduled PUSCH ports (i.e., the scheduled PUSCH rank).

At operation 1308, the UE is configured to transmit N_{TX} number of DMRS ports, regardless of the scheduled PUSCH ports, where N_{TX} is a number of configured UL transmission ports. In some embodiments, the number of UL transmission ports is the same as a maximum transmission rank that can be scheduled for a PUSCH.

Although FIG. 13 illustrates one example procedure for DMRS port extension 1300, various changes may be made to FIG. 13. For example, while shown as a series of operations, various operations in FIG. 13 could overlap, occur in parallel, occur in a different order, occur any number of times, be omitted, or replaced by other steps.

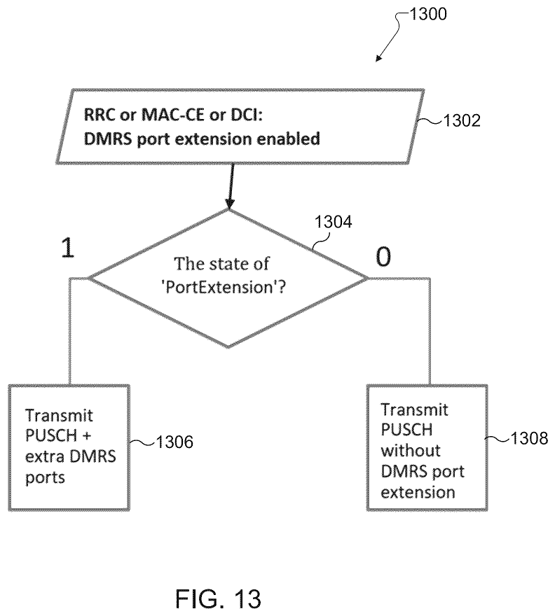

In some embodiments, a UE drops the extended DMRS port if the UE is power-limited, similar as shown in FIG. 14.

FIG. 14 illustrates an example procedure for extended DMRS port dropping 1400 according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure for extended DMRS port dropping could be used without departing from the scope of this disclosure.

In the example of FIG. 14, procedure 1400 beings at operation 1402. At operation 1402, a UE receives a message (such as an RRC, or MAC-CE, or DCI) including information indicating that DMRS port extension is enabled. In some embodiments, DMRS power boosting may be disabled. Alternatively, in some embodiment, DMRS power boosting may be enabled.

At operation, 1404, the UE determines whether to drop the extended DMRS port. If DMRS power boosting is disabled, and if transmit power per resource element P is greater than Pcₘₐₓ−1.76 dB, or if DMRS power boosting is enabled, and P>Pcₘₐₓ−3 dB, where Pcₘₐₓ is the maximum UE power at the resource element, then procedure 1400 continues at operation 1406. Otherwise, procedure 1400 continues at operation 1408.

At operation 1406, no transmission occurs on the extended DMRS port. At operation 1408, DMRS port extension is performed at the UE.

Although FIG. 14 illustrates one example procedure for extended DMRS port dropping 1400, various changes may be made to FIG. 14. For example, while shown as a series of operations, various operations in FIG. 14 could overlap, occur in parallel, occur in a different order, occur any number of times, be omitted, or replaced by other steps.

In some embodiments, a PUSCH is rate-matched around an SRS Type-2 for a UE if SRS Type-2 is configured and triggered in a TTI/slot and the PUSCH is also scheduled on the TTI/slot and resource blocks (RBs) assigned to the PUSCH have overlap with time/frequency resources of the SRS Type-2.

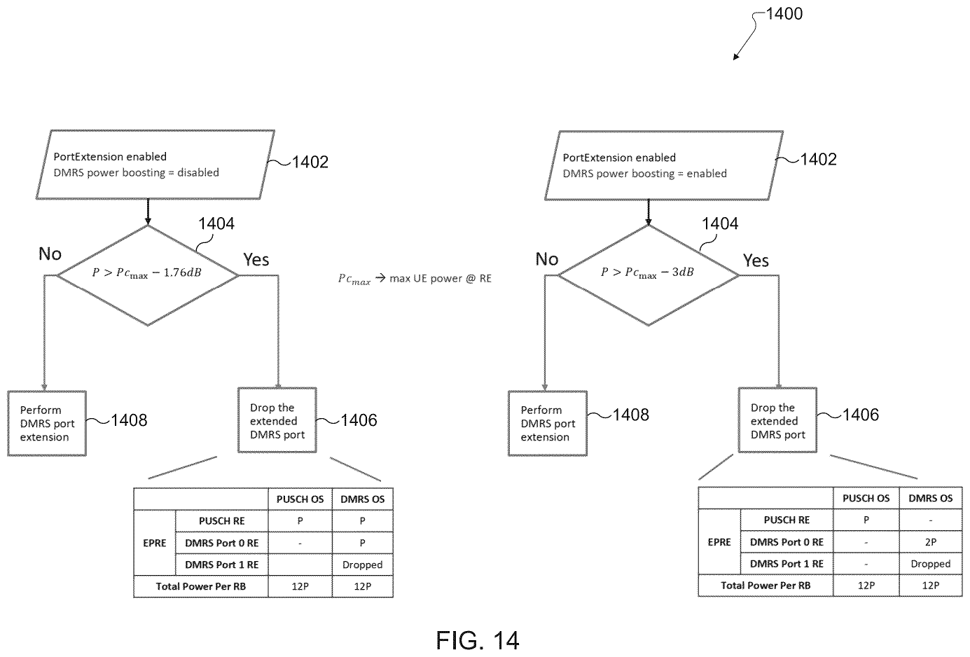

In some embodiments, a PUSCH may be rate-matched around full OFDM symbol(s) of a non-zero-power (NZP) SRS Type-2, similar as shown FIG. 15.

FIG. 15 illustrates an example of PUSCH rate-matching around full OFDM symbol(s) of NZP SRS Type-2 1500 according to embodiments of the present disclosure. The embodiment PUSCH rate-matching around full OFDM symbol(s) of NZP SRS Type-2 of FIG. 15 is for illustration only. Different embodiments of PUSCH rate-matching around full OFDM symbol(s) of NZP SRS Type-2 could be used without departing from the scope of this disclosure.

Although FIG. 15 illustrates one example of PUSCH rate-matching around full OFDM symbol(s) of SRS NZP Type-2 1500, various changes may be made to FIG. 15. For example, various changes to the number of RBs could be made, the allocation of the OFDM symbols could change, etc. according to particular needs.

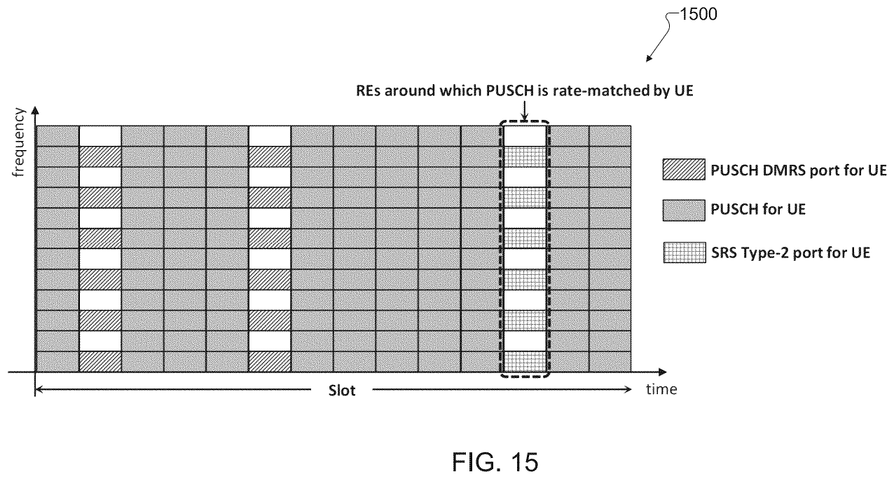

In some embodiments, a PUSCH may be rate-matched around SRS Type-2 REs, similar as shown FIG. 16.

FIG. 16 illustrates an example of PUSCH rate-matching around NZP SRS Type-2 REs 1600 according to embodiments of the present disclosure. The embodiment PUSCH rate-matching around NZP SRS Type-2 REs of FIG. 16 is for illustration only. Different embodiments of PUSCH rate-matching around NZP SRS Type-2 REs could be used without departing from the scope of this disclosure.

Although FIG. 16 illustrates one example of PUSCH rate-matching around SRS NZP Type-2 REs 1600, various changes may be made to FIG. 16. For example, various changes to the number of RBs could be made, the allocation of the REs could change, etc. according to particular needs.

In some embodiments, an RRC information element is used for configuring a PUSCH rate-matching option for a UE. For example, the RE element could configure PUSCH rate-matching similar as shown in FIG. 15 or FIG. 16.

In some embodiments, a Zero-Power (ZP) SRS Type-2 may be configured similarly as an NZP SRS Type-2, except that the UE does not transmit any UL signal over time/frequency resources of a ZP SRS Type 2. In the present disclosure, the terms “ZP SRS Type-2” and “ZP DMRS without PUSCH” are used interchangeably.

An example use case of ZP SRS Type-2 is for rate-matching of a PUSCH of other UEs around NZP SRS Type-2 transmission(s) of a UE. In this use case, UE #1 is configured with an NZP SRS Type-2 on a set of resources on a TTI/slot, and a PUSCH is scheduled for UE #2 on the same TTI/slot, and UE #2 is configured with a ZP SRS Type-2 on the same set of resources as the NZP SRS Type-2 of UE #1, and UE #2 rate-matches the PUSCH around the ZP SRS Type-2.

Another example use case of ZP SRS Type-2 is for UL interference measurement from neighboring cell(s). In this use case, UE #1 which is connected to cell #1 is configured with a ZP SRS Type-2 on a set of resources and UE #2 which is connected to cell #2 is configured with an NZP SRS Type-2 on the same set of resources as the NZP SRS Type-2 of UE #1. A BS in cell #1 measures UL interference from UE #2 by measuring a signal received over resource(s) of the ZP SR Type-2.

In some embodiments, a UE does not transmit any UL signal on the REs of a triggered ZP Type-2, and the UE, if scheduled with a PUSCH on the same TTI/slot as the ZP SRS Type-2, performs PUSCH rate-matching around the ZP SRS Type-2.

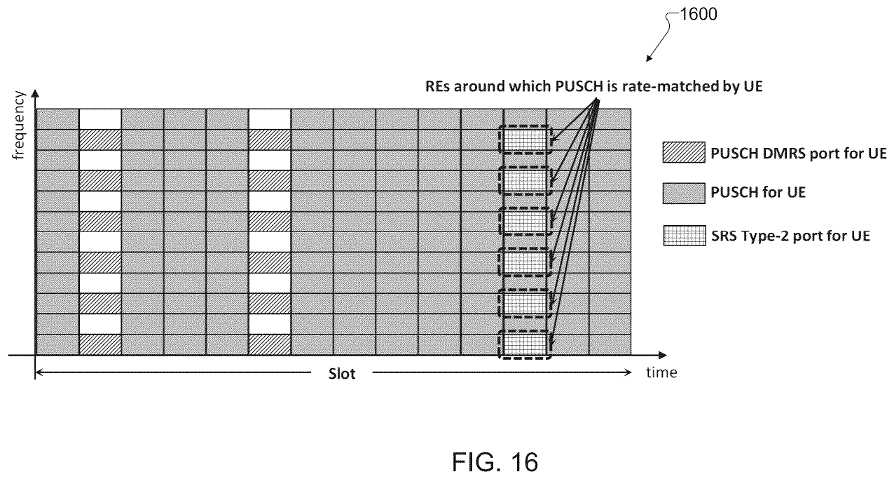

In some embodiments, a PUSCH may be rate-matched around full OFDM symbol(s) of ZP SRS Type-2, similar as shown FIG. 17.

FIG. 17 illustrates an example of PUSCH rate-matching around full OFDM symbol(s) of ZP SRS Type-2 1700 according to embodiments of the present disclosure. The embodiment PUSCH rate-matching around full OFDM symbol(s) of ZP SRS Type-2 of FIG. 17 is for illustration only. Different embodiments of PUSCH rate-matching around full OFDM symbol(s) of ZP SRS Type-2 could be used without departing from the scope of this disclosure.

Although FIG. 17 illustrates one example of PUSCH rate-matching around full OFDM symbol(s) of SRS ZP Type-2 1700, various changes may be made to FIG. 17. For example, various changes to the number of RBs could be made, the allocation of the OFDM symbols could change, etc. according to particular needs.

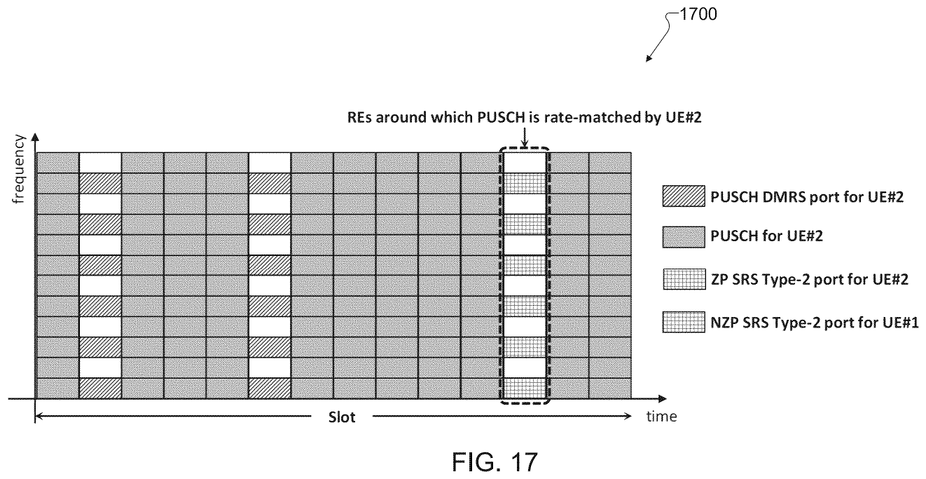

In some embodiments, a PUSCH may be rate-matched around ZP SRS Type-2 REs, similar as shown FIG. 18.

FIG. 18 illustrates an example of PUSCH rate-matching around ZP SRS Type-2 REs 1800 according to embodiments of the present disclosure. The embodiment PUSCH rate-matching around ZP SRS Type-2 REs of FIG. 18 is for illustration only. Different embodiments of PUSCH rate-matching around ZP SRS Type-2 REs could be used without departing from the scope of this disclosure.

Although FIG. 18 illustrates one example of PUSCH rate-matching around SRS ZP Type-2 REs 1800, various changes may be made to FIG. 18. For example, various changes to the number of RBs could be made, the allocation of the REs could change, etc. according to particular needs.

In some embodiments, an RRC information element is used for configuring a PUSCH rate-matching option for a UE. For example, the RE element could configure PUSCH rate-matching similar as shown in FIG. 17 or FIG. 18.

In some embodiments, SRS Type-2 transmission can be triggered via PUSCH scheduling DCI or a separate DCI, or both. In some embodiments, a DCI field is used to trigger SRS Type-2 transmission.

In some embodiments, a PUSCH scheduling DCI (a UL grant) is used to trigger an SRS Type-2. In embodiments such as these, a same set of RBs assigned to the scheduled PUSCH are used for transmission of the SRS Type-2.

In some embodiments, a separate DCI from a UL grant is used to trigger an SRS Type-2 without scheduling a PUSCH. In embodiments such as these, any of the following methods can be used to indicate a set of RBs for transmission of the triggered SRS Type-2:
a number of RB assignments can be specified in a table in standards specifications, and an entry in the table can be indicated to the UE in the DCI;
a number of RB assignments can be configured by higher layers, and one of the configured RB assignments can be indicated to the UE in the DCI;
a frequency-domain resource assignment field can be present on the separate DCI used for indicating the RB assignments to the UE.

In some embodiments, OFDM symbols for transmission of an SRS Type-2 are indicated in a DCI using explicit signaling. In embodiments such as these, any of the following methods can be used to indicate the OFDM symbols for transmission of the SRS Type-2:
a set of OFDM symbol assignments can be specified in a table in standards specifications, and an entry in the table can indicate the OFDM symbol assignments to the UE in the DCI;
a set of OFDM symbol assignments can be configured by higher layers, and one of the configured OFDM symbol assignments can be indicated to the UE in the DCI;
A bitmap of TTI/slot size can be used in the DCI to indicate to the UE which OFDM symbols are used for transmission of the SRS Type-2.

In some embodiments, OFDM symbols for transmission of an SRS Type-2 are indicated in a DCI using implicit signaling. In embodiments such as these, a range of OFDM symbols (i.e., a starting OFDM symbol and a number of OFDM symbols) is indicated in the DCI. In these embodiments, the actual SRS Type-2 OFDM symbols are higher layer configured SRS Type-2 symbols which fall within the indicated range of OFDM symbols.

In some embodiments, a DCI field is used for indication of triggered port(s) from a set of configured SRS Type-2 ports.

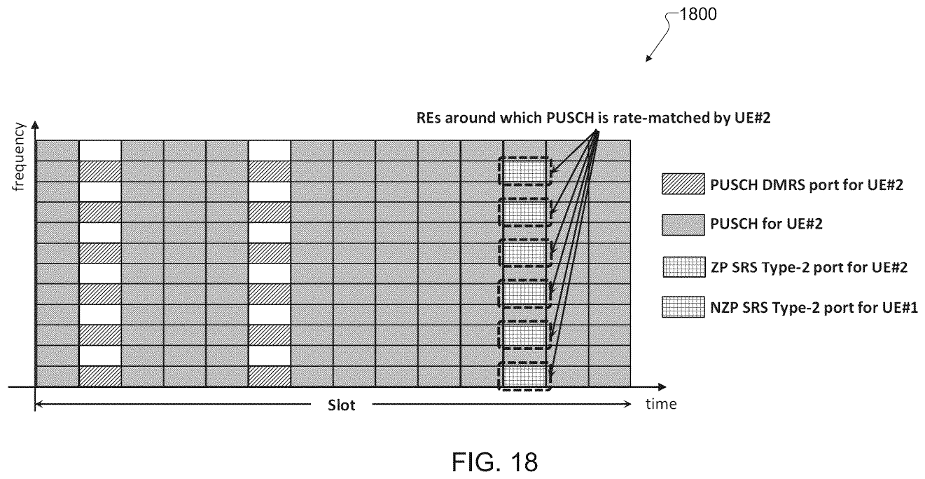

FIG. 19 illustrates an example method for transmission of an UL RS 1900 according to embodiments of the present disclosure. An embodiment of the method illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a method for transmission of an UL RS could be used without departing from the scope of this disclosure.

In the example of FIG. 19, method 1900 begins at step 1910. At step 1910, a UE (such as UE 116) receives, from a BS (such as BS 102), DCI including a trigger to transmit a UL RS.

In some embodiments, the DCI may further indicate time/frequency resources and antenna ports for transmission of the UL RS. In some embodiments, the UL RS may be transmitted in a number of extended DMRS ports corresponding with a number of scheduled PUSCH ports.

In some embodiments, the trigger to transmit the UL RS is a trigger to transmit the UL RS in extended DMRS ports. In embodiments such as these, the DCI may further include an indication of DMRS port numbers for the extended DMRS ports.

In some embodiments, the trigger to transmit the UL RS may be information scheduling one or more PUSCH RBs for transmission of the UL RS. In embodiments such as these, the UL RS may be transmitted in the scheduled one or more PUSCH RBs.

In some embodiments, the DCI may include at least one of an indication of a table entry, the table entry specifying a resource block (RB) assignment for transmission of the UL RS, and an indication of an RB assignment for transmission of the UL RS configured by higher layers.

In some embodiments, the DCI may include at least one of an indication of a table entry, the table entry specifying an OFDM symbol assignment for transmission of the UL RS, an indication of an OFDM symbol assignment for transmission of the UL RS configured by higher layers, a bitmap of slot size indicating OFDM symbols used for transmission of the UL RS, and a range of OFDM symbols for transmission of the UL RS.

At step 1920, the UE generates the UL RS based on a UL DMRS.

At step 1930, the UE transmits the UL RS.

In some embodiments, generating the UL RS based on the UL DMRS may comprise generating a pseudo-random binary sequence. In embodiments such as these, transmitting the UL RS may comprise modulating the pseudo-random binary sequence using quadrature phase shift keying (QPSK) modulation.

Although FIG. 19 illustrates one example method for transmission of an UL RS 1900, various changes may be made to FIG. 19. For example, while shown as a series of steps, various steps in FIG. 19 could overlap, occur in parallel, occur in a different order, occur any number of times, be omitted, or replaced by other steps.

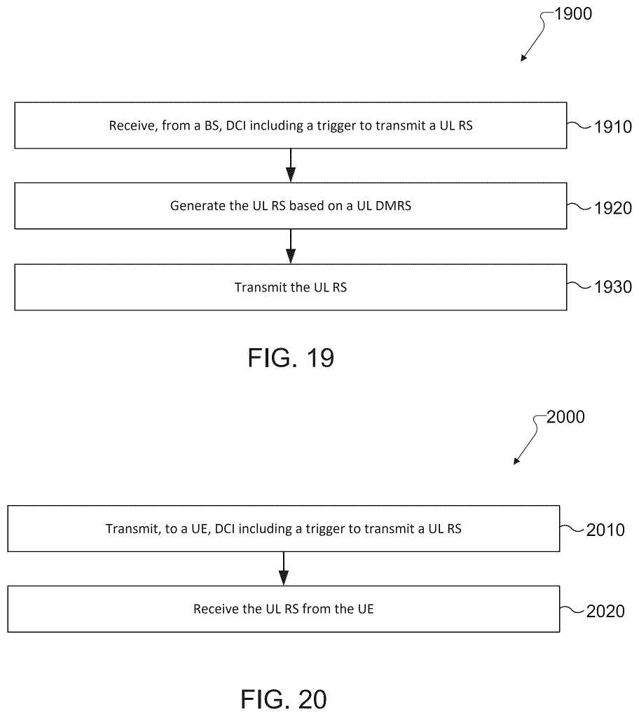

FIG. 20 illustrates an example method for reception of an UL RS 2000 according to embodiments of the present disclosure. An embodiment of the method illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a method for reception of an UL RS could be used without departing from the scope of this disclosure.

In the example of FIG. 20, method 2000 begins at step 2010. At step 2010, a BS (such as BS 102) transmits, to a UE (such as UE 116), DCI including a trigger to transmit a UL RS. In some embodiments, the DCI may further indicate time/frequency resources and antenna ports for transmission of the UL RS.

In some embodiments, the trigger to transmit the UL RS may be a trigger to transmit the UL RS in extended DMRS ports. In embodiments such as these, the DCI may further include an indication of DMRS port numbers for the extended DMRS ports.

In some embodiments, the trigger to transmit the UL RS may be information scheduling one or more PUSCH RBs for transmission of the UL RS. In embodiments such as these, the UL RS may be received in the scheduled one or more PUSCH RBs.

In some embodiments, the DCI may include at least one of an indication of a table entry, the table entry specifying a resource block (RB) assignment for transmission of the UL RS, and an indication of an RB assignment for transmission of the UL RS configured by higher layers.

In some embodiments, the DCI may include at least one of an indication of a table entry, the table entry specifying an OFDM symbol assignment for transmission of the UL RS, an indication of an OFDM symbol assignment for transmission of the UL RS configured by higher layers, a bitmap of slot size indicating OFDM symbols used for transmission of the UL RS, and a range of OFDM symbols for transmission of the UL RS.

At step 2020, the BS receives the UL RS from the UE. The UL RS may be generated based on a UL DMRS.

In some embodiments, the UL RS based on the UL DMRS may be generated based on a pseudo-random binary sequence. In embodiments such as these, the pseudo-random binary sequence may be modulated using quadrature phase shift keying (QPSK) modulation for transmission of the UL DMRS.

Although FIG. 20 illustrates one example method for reception of an UL RS 2000, various changes may be made to FIG. 20. For example, while shown as a series of steps, various steps in FIG. 20 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive, from a base station (BS), downlink control information (DCI) including a trigger to transmit an uplink (UL) reference signal (RS); and
a processor operably coupled to the transceiver, the processor configured to generate the UL RS based on a UL demodulation reference signal (DMRS),
wherein the transceiver is further configured to transmit the UL RS.

2. The UE of claim 1, wherein:
to generate the UL RS based on the UL DMRS, the processor is further configured to generate a pseudo-random binary sequence;
to transmit the UL RS, the transceiver is further configured to modulate the pseudo-random binary sequence using quadrature phase shift keying (QPSK) modulation; and
the DCI further indicates time/frequency resources and antenna ports for transmission of the UL RS.

3. The UE of claim 1, wherein:
the trigger to transmit the UL RS is a trigger to transmit the UL RS in extended DMRS ports; and
the DCI further includes an indication of DMRS port numbers for the extended DMRS ports.

4. The UE of claim 3, wherein the transceiver is further configured to transmit the UL RS in a number of extended DMRS ports corresponding with a number of scheduled PUSCH ports.

5. The UE of claim 1, wherein the trigger to transmit the UL RS is information scheduling one or more physical uplink shared channel (PUSCH) resource blocks (RBs) for transmission of the UL RS, and the transceiver is further configured to transmit the UL RS in the scheduled one or more PUSCH RBs.

6. The UE of claim 1, wherein the DCI includes at least one of:
an indication of a table entry, the table entry specifying a resource block (RB) assignment for transmission of the UL RS; and
an indication of an RB assignment for transmission of the UL RS configured by higher layers.

7. The UE of claim 1, wherein the DCI includes at least one of:
an indication of a table entry, the table entry specifying an orthogonal frequency division multiplexing (OFDM) symbol assignment for transmission of the UL RS;
an indication of an OFDM symbol assignment for transmission of the UL RS configured by higher layers;
a bitmap of slot size indicating OFDM symbols used for transmission of the UL RS; and
a range of OFDM symbols for transmission of the UL RS.

8. A base station (BS) comprising:
a processor; and
a transceiver operably coupled to the processor, the transceiver configured to:
transmit, to a user equipment (UE), downlink control information (DCI) including a trigger to transmit an uplink (UL) reference signal (RS); and
receive the UL RS from the UE,
wherein the UL RS is generated based on a UL demodulation reference signal (DMRS).

9. The BS of claim 8, wherein:
the UL RS based on the UL DMRS is generated based on a pseudo-random binary sequence;
the pseudo-random binary sequence is modulated using quadrature phase shift keying (QPSK) modulation for transmission of the UL DMRS; and
the DCI further indicates time/frequency resources and antenna ports for transmission of the UL RS.

10. The BS of claim 8, wherein:
the trigger to transmit the UL RS is a trigger to transmit the UL RS in extended DMRS ports; and
the DCI further includes an indication of DMRS port numbers for the extended DMRS ports.

11. The BS of claim 8, wherein the trigger to transmit the UL RS is information scheduling one or more physical uplink shared channel (PUSCH) resource blocks (RBs) for transmission of the UL RS, and the transceiver is further configured to receive the UL RS in the scheduled one or more PUSCH RBs.

12. The BS of claim 8, wherein the DCI includes at least one of:
an indication of a table entry, the table entry specifying a resource block (RB) assignment for transmission of the UL RS; and
an indication of an RB assignment for transmission of the UL RS configured by higher layers.

13. The BS of claim 8, wherein the DCI includes at least one of:
an indication of a table entry, the table entry specifying an orthogonal frequency division multiplexing (OFDM) symbol assignment for transmission of the UL RS;
an indication of an OFDM symbol assignment for transmission of the UL RS configured by higher layers;
a bitmap of slot size indicating OFDM symbols used for transmission of the UL RS; and
a range of OFDM symbols for transmission of the UL RS.

14. A method of operating a user equipment (UE), the method comprising:
receiving, from a base station (BS), downlink control information (DCI) including a trigger to transmit an uplink (UL) reference signal (RS);
generating the UL RS based on a UL demodulation reference signal (DMRS); and
transmitting the UL RS.

15. The method of claim 14, wherein:
generating the UL RS based on the UL DMRS comprises generating a pseudo-random binary sequence;
transmitting the UL RS comprises modulating the pseudo-random binary sequence using quadrature phase shift keying (QPSK) modulation; and
the DCI further indicates time/frequency resources and antenna ports for transmission of the UL RS.

16. The method of claim 14, wherein:
the trigger to transmit the UL RS is a trigger to transmit the UL RS in extended DMRS ports; and
the DCI further includes an indication of DMRS port numbers for the extended DMRS ports.

17. The method of claim 16, wherein the UL RS is transmitted in a number of extended DMRS ports corresponding with a number of scheduled PUSCH ports.

18. The method of claim 14, wherein the trigger to transmit the UL RS is information scheduling one or more physical uplink shared channel (PUSCH) resource blocks (RBs) for transmission of the UL RS, and the UL RS is transmitted in the scheduled one or more PUSCH RBs.

19. The method of claim 14, wherein the DCI includes at least one of:
an indication of a table entry, the table entry specifying a resource block (RB) assignment for transmission of the UL RS; and
an indication of an RB assignment for transmission of the UL RS configured by higher layers.

20. The method of claim 14, wherein the DCI includes at least one of:
an indication of a table entry, the table entry specifying an orthogonal frequency division multiplexing (OFDM) symbol assignment for transmission of the UL RS;
an indication of an OFDM symbol assignment for transmission of the UL RS configured by higher layers;
a bitmap of slot size indicating OFDM symbols used for transmission of the UL RS; and
a range of OFDM symbols for transmission of the UL RS.
